(19) United States
(12) Patent Application Publication
(10) Pub. No.: US 2006/0014452 A1
(43) Pub. Date: Jan. 19, 2006

(54) Packaging material for metal

(76) Inventor: Martin Vido, Mission (CA)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/517,795

(22) PCT Filed: Jun. 11, 2003
(86) PCT No.: PCT/CA03/00894

§ 371 Date: Aug. 26, 2005

(30) Foreign Application Priority Data
Jun. 11, 2002 (CA) 2390278

(51) Int. Cl. B32B 27/12; B32B 27/04; B32B 27/32

(52) U.S. Cl. 442/41; 442/38

(57) ABSTRACT

A multi-layered packaging material for metal with improved anti-corrosion properties is made from polyolefins, preferably polyethylene. The material has a high tensile strength middle layer comprising a woven scrim, preferably made of high-density polyethylene tapes with decitex from 500 to 2500 grams per 10,000 meters. The woven layer is laminated on the outer side to a layer of low-density polyethylene. The outer layer has a very low moisture and vapor transmission rate and is almost impermeable. It protects the wrapped good from damaging elements in the atmosphere, including vapors and moisture. The middle layer is laminated on the inside to a polymer sheet, preferably low-density polyethylene, impregnated with a blend of corrosion inhibitors. The corrosion inhibitor blend comprises both volatile and contact corrosion inhibitors.

### TECHNICAL FIELD OF THE INVENTION

The present invention is directed to a multi-layered sheet with improved anti-corrosive properties for use in packaging metal goods. The sheet includes both vapor and contact corrosion inhibitors, allowing two corrosion inhibition mechanisms to work independently.

### BACKGROUND OF THE INVENTION

Most metals are susceptible to corrosion from ambient or atmospheric conditions. The metal packaging industry has successfully developed various methods and compounds for reducing corrosion of metals during storage and use. However, the effectiveness and shelf life of metal wrapping materials still requires improvement. Developing new formulas for corrosion inhibitors and new methods of incorporating them in the packaging material are two major areas of research.

Commonly, volatile corrosion inhibitors (also called vapor phase corrosion inhibitors) are used in wrapping materials for metal parts to protect them from corroding. By vaporization from a solid or liquid state, the volatile corrosion inhibitors reach the surface of the object to be protected and form a stable bond with the metal surface. The limitations for good efficiency are (1) the transfer of the inhibitors to the metallic surface, (2) the rate of transfer, and (3) the effectiveness of the packaging seal around the metal object, i.e. to prevent the inhibitor from escaping into the atmosphere.

Contact corrosion inhibitors are transferred to the metal surface by creeping of the inhibitors from the wrapping material directly to the metal. This allows the inhibitor to stay with the metal even if the package is not sealed properly.

### SUMMARY OF INVENTION

The present invention uses a combination of contact corrosion inhibitors and volatile corrosion inhibitors to improve the protection against corrosion. Since the multi-layered packaging sheet is all plastic and hence flexible, the inner layer is in physical contact with the metal part, allowing efficient transfer of the contact corrosion inhibitor.

It is an object of the present invention to provide a high tensile strength packaging material that can constantly and adequately supply corrosion inhibitors to the wrapped metallic items.

It is a further object of the invention to provide a packaging material that contains contact corrosion inhibitors to enhance corrosion inhibition.

It is a further object of the invention to provide a packaging material that contains volatile corrosion inhibitors to prevent corrosion via sublimation of volatile, solid corrosion-inhibiting components.

Another object of the invention is to provide a packaging material that is impermeable, to prevent moisture and damaging elements of the atmosphere from reaching the wrapped metal part as well as to prevent the volatile corrosion inhibitor from escaping to the atmosphere through the packaging material.

According to a preferred embodiment of the invention, the packaging material is a multi-layered sheet having a middle layer comprising a woven scrim made from polyolefin tapes. The inner layer preferably carries from 0.5 to 15.0 percent by weight contact corrosion inhibitors. Through the contact of the inner layer with the metal part, the contact corrosion inhibitors will creep and transfer to the surface of the metal. The inner layer also preferably includes a vapor corrosion inhibition. The concentration of the volatile corrosion inhibitors range from 0.1 to 0.9 percent of the inner layer weight. The sheet material includes a highly water-resistant outer layer, made of polyolefin resin. This layer is laminated to the woven scrim and provides a very low moisture/vapor transmission rate.

According to a second embodiment, the sheet material comprises the scrim and inner layers, but does not include the water-resistant outer layer.

### BRIEF DESCRIPTION OF DRAWING

FIG. 1 is an enlarged cross-sectional view through the preferred embodiment of the sheet material according to the invention.

### DETAILED DESCRIPTION OF PREFERRED EMBODIMENT

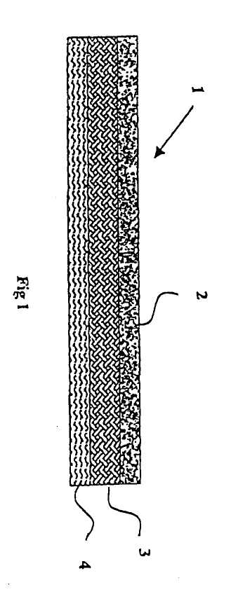

Referring to FIG. 1, the multi-layered sheet material 1 comprises three layers, namely a woven scrim 3, an inner polyolefin film 4 impregnated with corrosion inhibitors, and an outer polyolefin film 2. The sheet material preferably has a width in the range of 4 to 180 inches.

Woven scrim 3 is preferably made from polyolefin tapes, preferably having a width 1.5 to 6 mm. The number of tapes in the machine direction may be in the range of 4 to 16 tapes per inch. The decitex of the tapes (grams per 10,000 meters) is preferably in the range of 500-2,500. The number of tapes in the cross direction may be in the range of 2 to 16 tapes per inch. The scrim weight is preferably from 30 to 400 grams per square meter. Scrims of this type, made from tapes having high mechanical and tensile strength, are known in the art.

The woven scrim 3 is preferably laminated on one side with polyolefin film 2. This layer forms the outer surface of the sheet material and imparts additional protection against the transmission of atmospheric gases and water into the sheet material. The thickness of layer 2 is preferably between 0.5 and 3.0 mils, adding a weight of 12 to 72 grams per square meter to the sheet material. This layer preferably comprises a blend of low density polyethylene and linear low density polyethylene.

The inner layer 4 (i.e. the layer that, in use, contacts the wrapped metal item) carries volatile corrosion inhibitors in concentrations of 0.1 to 0.9 percent by weight (i.e. relative to the weight of the inner layer) and contact corrosion inhibitors in concentrations of 0.5 to 15 percent by weight. The volatile and contact corrosion inhibitors can be selected from ones well known in the art. For example, the volatile corrosion inhibitor can be a nitrite compound such as dicyclohexylammonium nitrite; the contact corrosion inhibitor can be an alkali metal nitrite or benzoate, such as sodium nitrite or sodium benzoate. Any of a wide variety of volatile and contact corrosion inhibitors known in the art can be selected for use in the invention. The volatile corrosion inhibitors are transferred to the metal surface by volatilizing from the solid phase and inhibit corrosion by forming a protective layer around the metal surface. The contact corrosion inhibitors protect by creeping at the metal surface. The sheet material is preferably able to supply corrosion inhibitors to the metal item for a period of up to two years, effectively inhibiting corrosion.

All three layers of sheet material 1 may be made from suitable polyolefins, for example, polypropylene, or low or high density polyethylene, or a combination thereof. They are bonded together by laminating techniques well known in the art.

According to a second preferred embodiment of the invention (not illustrated in the drawing), the sheet material comprises only woven scrim 3 and inner layer 4. There is no outer coating layer 2 so the scrim forms the outer layer. In this embodiment, inner layer 4 serves the function of preventing penetration by the atmosphere through the sheet material and to the wrapped metal product.

The corrosion inhibitors are incorporated into the resin used to make the film of the sheet material by methods well known in the art. Typically, the compositions are compounded with a carrier resin in a master batch, which is then mixed and diluted with the base resin used to make the film.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

1. A sheet material for wrapping metal goods, in order to protect said metal goods from corrosion, comprising:
(a) a woven scrim having an inner side and an outer side;
(b) a polyolefin film laminated on said inner side of said scrim, said film comprising:
(i) 0.5-15% by weight of a contact corrosion inhibitor; and
(ii) 0.1-0.9% by weight of a volatile corrosion inhibitor.

2. A sheet material according to claim 1 further comprising a polyolefin film laminated on said outer side of said scrim.

3. A sheet material according to claim 1 wherein said scrim comprises polyolefin tapes.

4. A sheet material according to claim 3 wherein said scrim comprises high density polyethylene.

5. A sheet material according to claim 3 wherein said scrim is polypropylene.

6. A sheet material according to claim 3 wherein said scrim comprises 4-16 tapes per inch in the machine direction and 2-16 tapes in the cross direction.

7. A sheet material according to claim 6 wherein said scrim has a weight in the range of 30-400 grams per square meter.

8. A sheet material according to claim 1 wherein said inner polyolefin film has a thickness in the range of 0.5-3.0 mils.

9. A sheet material according to claim 8 wherein said inner polyolefin film comprises low density polyethylene.

10. A sheet material according to claim 8 wherein said inner polyolefin film comprises a blend of low density polyethylene and linear low density polyethylene.

11. A sheet material according to claim 8 wherein said inner polyolefin film comprises polypropylene.

12. A sheet material according to claim 2 wherein said outer film has a thickness in the range of 0.5-3.0 mils.

13. A sheet material according to claim 2 wherein said outer polyolefin film comprises low density polyethylene.

14. A sheet material according to claim 2 wherein said outer polyolefin film comprises a blend of low density polyethylene and linear low density polyethylene.

15. A sheet material according to claim 2 wherein said outer polyolefin film comprises polypropylene
